(19) United States
(12) Patent Application Publication
(10) Pub. No.: US 2019/0061864 A1
(43) Pub. Date: Feb. 28, 2019

(54) HEIGHT-ADJUSTABLE STEERING DEVICE FOR SMALL VEHICLES

(71) Applicant: Brake Force One GmbH, Tuebingen (DE)

(72) Inventors: STEFAN STARK, FRIESENHAGEN (DE); PETER VOITL, PFORZHEIM (DE)

(73) Assignee: Brake Force One GmbH, TUEBINGEN (DE)

(21) Appl. No.: 16/114,353

(22) Filed: Aug. 28, 2018

(30) Foreign Application Priority Data
Aug. 29, 2017 (EP) 17188440.6

(51) Int. Cl. B62K 21/16; F16B 7/14

(52) U.S. Cl. CPC B62K 21/16; B62K 11/14; F16B 7/149; F16B 7/1481

(57) ABSTRACT

A steering device for small vehicles has a transverse control arm which is situated on a height-adjustable handlebar formed form two telescopic tubes. The inner tube has at least two openings or grooves which are formed at different heights and into which a latching element mounted in the outer tube can latch into position. A height-adjustment and locking device in the form of a clamping sleeve surrounds the two tubes at their connection point and is displaceable along the inner tube in the direction of the outer tube against the force of a spring. The locking device is provided, on its inner side, with a conically tapering end portion which engages around the outer tube and, in the relaxed state of the spring, acts on an outer surface of the latching element, which protrudes radially outward through an opening in the outer tube, and presses the latching element radially inward.

### CROSS-REFERENCE TO RELATED APPLICATIONS

This application claims priority under 35 USC 119 of European Patent Application No. 17188440.6, filed on Aug. 29, 2017, the disclosure of which is herein incorporated by reference.

### BACKGROUND OF THE INVENTION

The invention relates to a steering device for small vehicles which are operated via muscle power and/or electrically and comprise a transverse control arm which is situated on a height-adjustable handlebar, wherein the handlebar comprises two telescopic tubes and the inner tube comprises at least two openings or grooves which are formed at different heights and into which a latching element can latch into position, the latching element being radially movably mounted in the outer tube.

Such steering devices are provided, in particular, on vehicles such as bicycles, two- or three-wheeled scooters, or hoverboards.

The increasing congestion of the urban road infrastructure, the shortage of parking area, and environmental impact require novel, sustainable individual mobility solutions for the city of tomorrow. An essential key to solving this challenge lies in the optimal linking of various forms of transportation. Due to modern information and communication technologies, optimal route planning from door to door using several available modes of transportation is already possible today. One challenge in this case, however, is that of bridging the paths between various modes of transportation. In this regard, the demand is growing for micromobility solutions, which can be carried along at any time, for bridging the distances between main modes of transportation and the destination (last-mile mobility). The above-described vehicles can be successfully utilized for this purpose, in particular when they can be taken apart or folded up.

In addition, the trend toward taking private vacations with mobile homes, yachts, and cars continues unabated. In this area, the demand for small compact vehicles (folding bicycles, scooters, electric scooters, . . . ) is also enormous. Moreover, micromobility solutions will be utilized to an increasing extent wherever short distances must be bridged often and in a short amount of time. This includes, for example, large factory premises, trade shows, airports, inner cities, and other public and private premises.

In the case of all these small vehicles, a telescopic handlebar is very important in order to adjust the height of the handlebar. Only in this way is it possible to ergonomically travel with the aid of these vehicles. In addition, a telescopic handlebar also provides for very small storage dimensions of the vehicles, and so the vehicles can be easily stored in a trunk, in the train, or in a mobile home.

With respect to the height adjustment of telescopic tubes, a distinction is to be made, in principle, between two types of locking. On the one hand, the height adjustment can take place in a friction-locking manner, as is the case with broomsticks, seat posts, or photographic tripods, with the aid of twist locks which must be tightened, or the telescopic tubes are adjusted with the aid of a positive engagement. Telescopic tubes can be latched into position or adjusted at predefined positions with the aid of a positive engagement which can be established via pins, balls, or other types of push-in connections.

On the presently known small vehicles having a telescopic handlebar, the height adjustment of the handlebar generally takes place by way of a combination of non-positive and positive engagement. A quick-release mechanism fixedly clamps the outer steering tube on the extendable steering tube and balls, which have been locked into position with the aid of springs, prevent a slipping and, therefore, an unintentional height adjustment of the handlebar. In order to adjust the height of the handlebar, the quick-release mechanism must first be released and the balls must be pressed out of their seat in the steering tube. When several ball recesses are provided for the individual adaptation of the handlebar height, the balls must be pressed again, at each of these recesses, until the handlebar has reached the desired height.

### SUMMARY OF THE INVENTION

The problem addressed by the present invention is that of creating a steering device for small vehicles comprising a telescopic handlebar, which allows for a rapid adaptation of the handlebar height.

The problem is solved by a steering device for small vehicles which are operated via muscle power and/or electrically and comprise a transverse control arm which is situated on a height-adjustable handlebar, wherein the handlebar comprises two telescopic tubes and the inner tube comprises at least two openings or grooves which are formed at different heights and into which a latching element can latch into position, the latching element being radially movably mounted in the outer tube, the steering device being characterized in that a height-adjustment and locking device is provided, which comprises a clamping sleeve surrounding the two tubes at their connection point and is displaceable along the inner tube in the direction of the outer tube against the force of a spring, and which is provided, on its inner side, with a conically tapering end portion which engages around the outer tube and, in the relaxed state of the spring, acts on an outer surface of the latching element, which protrudes radially outward through an opening in the outer tube, and thereby presses the latching element radially inward.

Due to a movement of the clamping sleeve toward the outer tube against the force of the spring, the conical end portion of the clamping sleeve releases the outer surface of the latching element, and therefore the inner tube can now be freely displaced in the outer tube. The latching element is pressed radially outward out of the opening or groove in this case. The latching element latches into a new opening or groove only when the clamping sleeve is released and, therefore, moves away from the outer tube again due to the force of the spring, and therefore its conical end portion acts on the outer surface of the latching element again and presses the outer surface of the latching element radially inward. As a result, the locking of the handlebar can be released and a height adjustment of the handlebar can be carried out with only one move of the hand. The need to actively press the latching element out of every available latching opening by hand can be dispensed with in this solution.

Preferably, the outer surface of the latching element can also be conically configured, corresponding to the conical end portion of the clamping sleeve. As a result, a secure self-locking of the handlebar can be achieved, which ensures that the handlebar height does not unintentionally shift as a result of the load of the transverse control arm.

In one preferred embodiment of the steering device, the spring is situated between a first guide bush, which is non-rotatably situated in the end portion of the outer tube and comprises a radial passage opening for the latching element, and a second guide bush, which surrounds the inner tube, and fastens the clamping sleeve on the second guide bush. As a result, the clamping sleeve can be displaced, along with the second guide bush, along the inner tube.

Further advantages result when the inner tube includes a flattened circumferential portion, and the first guide bush includes, on its inner circumference, a corresponding flattened portion, and so the flattened portions of the inner tube and of the first guide bush form an anti-torsion safeguard of the inner tube with respect to the outer tube. In addition, the two corresponding flattened portions provide for the torque transmission between the inner tube comprising the transverse control arm and the outer tube which is connected to an axle for the wheel or the wheels of the vehicle.

In addition, the openings or grooves can be situated in the flattened circumferential portion of the inner tube. As a result, it is easily possible to situate the latching element in the hollow space present between the flattened portion of the inner tube and the outer tube. As a result, latching elements deviating from the spherical shape can be utilized, for example, essentially wedge-shaped elements.

It can also be provided that the inner edge of the first guide bush forms a safeguard against the inner tube being pulled out, the inner tube being provided, at its end, with a radially screwed-in screw which impacts the lower edge of the first guide bush when the inner tube is pulled too far out of the outer tube. For the assembly of the steering device, it is advantageous when an access opening to the screw on the inner tube is provided in the outer tube and the access opening can be covered toward the outside by an annular body, wherein the annular body forms a stop for the movement of the clamping sleeve. The annular body then forms not only a cover for the access opening, but rather, simultaneously, a stop which facilitates the handling of the clamping sleeve, when the stop is moved in order to release the locking of the handlebar.

In order to facilitate the displacement of the inner tube in the outer tube, the edges of the openings or grooves of the inner tube and the outer contour of the latching element can be advantageously configured in such a way that, upon release of the outer surface of the latching element by the conical portion of the clamping sleeve, the latching element can be moved out of the openings or grooves of the inner tube simply by moving the inner tube relative to the outer tube. For this purpose, the edges of the slots or openings can be rounded, in particular. Corresponding thereto, the tip of the latching element can also have a rounded shape.

The spring can preferably be a coil spring.

When the steering device is utilized for an electrically driven vehicle and/or for controlling hydraulic braking systems, electrical and/or hydraulic lines can be routed in the interior of the tubes.

The lines can be designed preferably in the shape of a spiral in order to compensate the change in length of the handlebar.

The problem is also solved by a steering device for small vehicles which are operated via muscle power and/or electrically and comprise a transverse control arm which is situated on a height-adjustable handlebar, wherein the handlebar comprises two telescopic tubes and the inner tube comprises at least two tubes into which a latching element can be adjusted, the latching element being radially movably mounted in the outer tube. A height-adjustment and locking device is provided, which comprises a clamping sleeve surrounding the two tubes at their connection point, is rotatable against the force of a torsion spring, and is provided, on its inner side, with an eccentrically extending wall portion which engages around the outer tube and, in the relaxed state of the torsion spring, acts on an outer surface of the latching element, which protrudes radially outward through an opening in the outer tube, and thereby presses the latching element radially inward, and releases the latching element when the clamping sleeve makes a turning motion against the force of the torsion spring.

In this solution, the latching element is therefore not unlocked by way of a displacement motion of a clamping sleeve, but rather by a way of a turning motion of the clamping sleeve. In the case of this solution as well, an unlocking and locking of the latching connection of the two tubes is possible with one move of the hand. The inner tube can also comprise a flattened portion as an anti-torsion safeguard, wherein the grooves or slots for accommodating the latching element are situated in this flattened portion.

### BRIEF DESCRIPTION OF THE DRAWINGS

One preferred exemplary embodiment of a steering device according to the invention is described in detail in the following with reference to the drawing.

In the drawing:

FIG. 1 shows a front view of a steering device according to the invention;

FIG. 2 shows a longitudinal section through the steering device from FIG. 1;

FIG. 3 shows an enlarged detailed representation of the longitudinal section from FIG. 2;

FIG. 4 shows a cross-section through the steering device from FIG. 1 along the line IV-IV; and

FIG. 5 shows a detailed view of a guide bush of the steering device from FIG. 1.

### DETAILED DESCRIPTION OF THE EMBODIMENTS

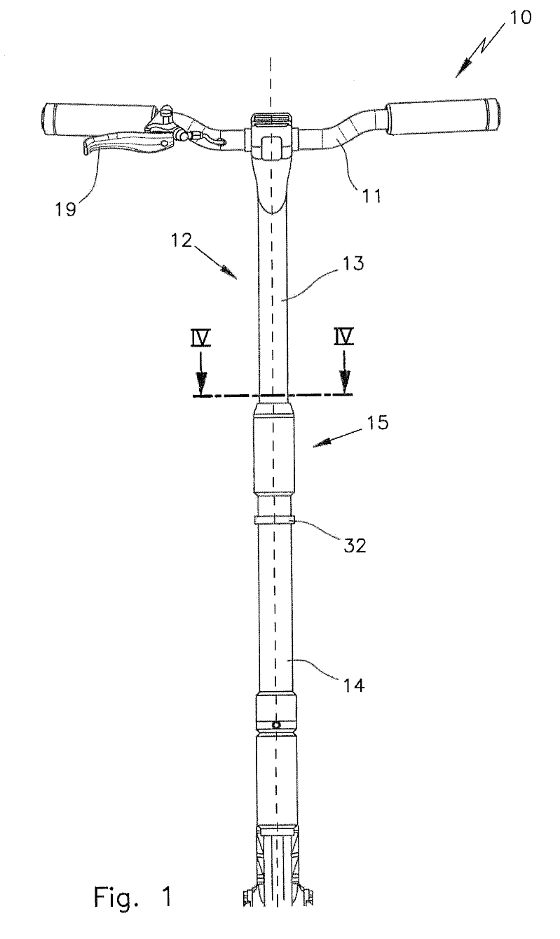

FIG. 1 shows a steering device 10 for a small vehicle which is not represented in greater detail here, comprising a transverse control arm 11 which is fastened on a handlebar 12. The handlebar 12 is formed from two telescopic tubes 13 and 14, wherein the tube 13 is guided in the outer tube 14. A height adjustment and locking device 15 is situated in the connecting area of the tubes 13, 14.

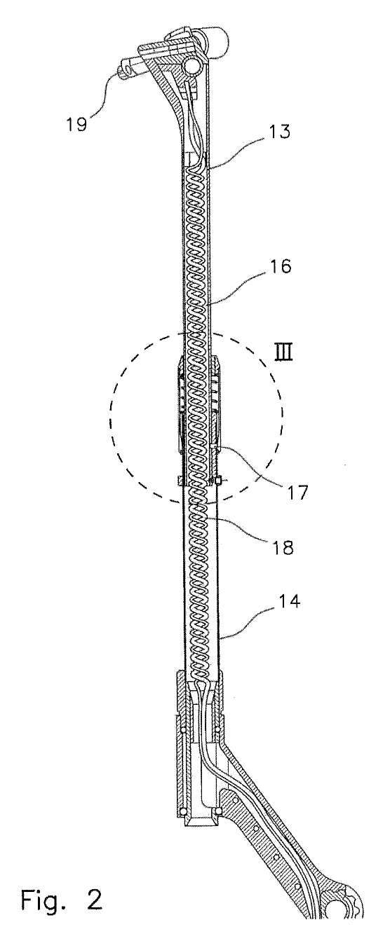

As the longitudinal section from FIG. 2 illustrates, the inner tube 13 comprises two latching grooves 16, 17 which, together with the height-adjustment and locking device 15, define two different height settings for the handlebar 12. In addition, spiral electrical and hydraulic lines 18 are routed in the interior of the tubes 13, 14, which connect, for example, a brake lever 19 on the transverse control arm 11 to a hydraulic brake which is not represented further here. Due to the spiral shape, the lines 18 can compensate a change in length of the handlebar 12.

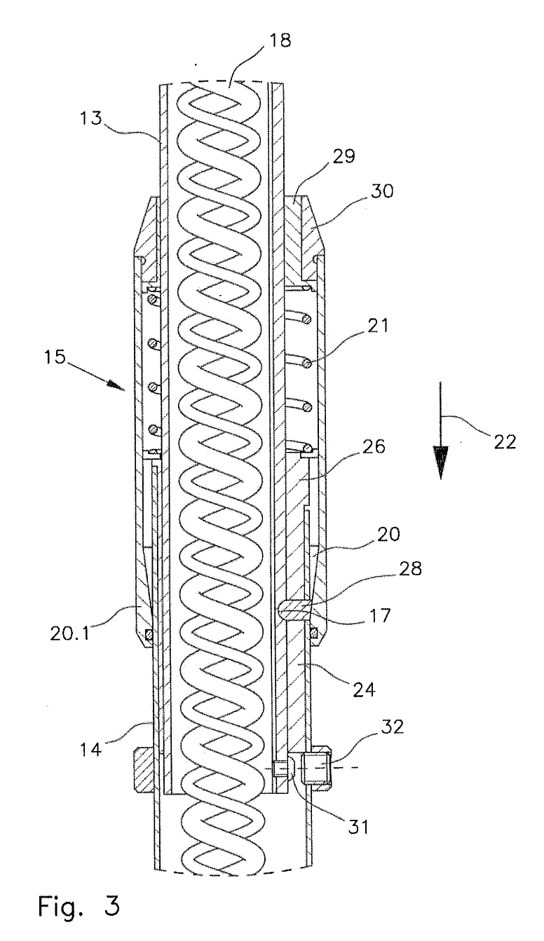

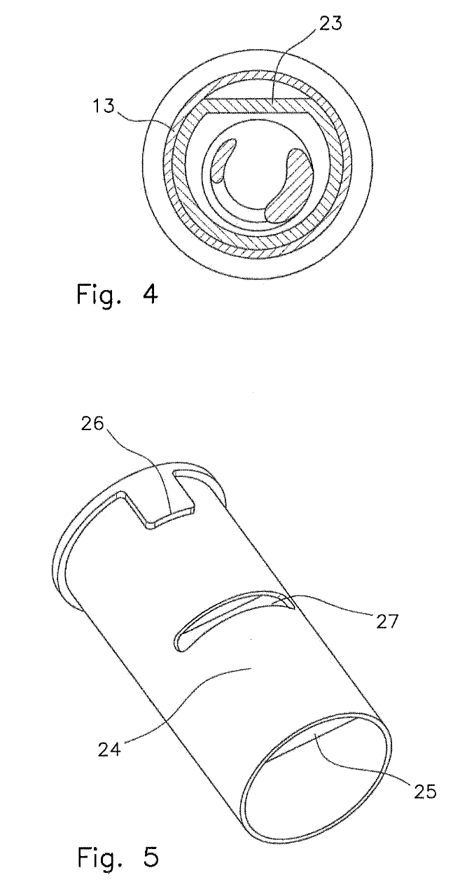

FIG. 2 and, in particular, the detailed representation from FIG. 3 illustrate the design of the height-adjustment and locking device 15. The locking and height-adjustment device 15 comprises a clamping sleeve 20 which extends beyond the connecting area of the two tubes 13 and 14 and is displaceable against the force of a spring 21 in the arrow direction 22. The inner tube 13 comprises a flattened circumferential portion 23 which is apparent, in particular, in the sectional representation from FIG. 4. In FIG. 3, the flattening is apparent at the greater distance of the clamping sleeve 20 to the inner tube 13 on the right side of the drawing. A guide bush 24 which includes a corresponding flattening 25, as illustrated in FIG. 5, is inserted in the outer tube 14. In addition, the guide bush 24 is provided with an engagement portion 26 which engages into a corresponding recess on the outer tube 14. As a result, the guide bush 24 is non-rotatably anchored in the outer tube 14. The two flattenings 23, 25 ensure that the inner tube 13 also cannot rotate with respect to the outer tube 14. In addition, a torque transmission between the tubes 13, 14 is possible via the two flattenings 23, 25, and so the steering motions at the transverse control arm 11 can be transmitted to wheels of the vehicle, which are not represented here.

The guide bush 24 as well as the outer tube 14 both comprise a slot-shaped opening 27 (see FIG. 5), in which a latching element 28 is radially displaceably mounted. The latching element 28 includes, on its radially outer side, a bevel which interacts with a conical end portion 20.1 of the clamping sleeve 20. If the clamping sleeve 20 is not moved by hand in the arrow direction 22, it presses the spring 21 into the uppermost position which is shown in FIG. 3, in which the conical end portion 20.1 of the clamping sleeve 20 presses the latching element radially inward into the groove 17 of the inner tube 13. Therefore, the two tubes 13, 14 are locked to each other at this height position.

For the purpose of moving the clamping sleeve 20, a second guide bush 29 is situated on the inner tube, which engages around the inner tube 13 and forms an upper stop for the coil spring 21. The guide bush 29 is surrounded by a cover ring 30, on which the clamping sleeve 20 is fastened. By way of a displacement of the cover ring 30 together with the guide bush 29 and the clamping sleeve 20, the conical end portion 20.1 thereof detaches from the latching element 28. A cavity is thereby formed between the latching element 28 and the clamping sleeve 20, which makes it possible to move the latching element 28 radially outward out of the groove 17 in the inner tube 13 by way of a displacement of the inner tube 13 in the tube 14, and so, for example, the inner tube 13 can be completely retracted into the outer tube 14 until the latching element 28 is positioned opposite the groove 16 in the inner tube. By way of a release of the clamping sleeve 20 or the cover ring 30, the clamping sleeve 20 moves upward, due to the spring force, and the conical end portion 20.1 of the clamping sleeve 20 presses the latching element 28 into the groove 16. The two tubes 13, 14 are then locked to each other in this position. It is understood that more than only two grooves 16, 17 can be provided in the inner tube 13, and so an arbitrary length adjustment of the handlebar 12 is possible.

As a safeguard against the inner tube 13 being pulled out, a screw 31 is screwed into the lower end of the inner tube 13. This screw 31 impacts the lower edge of the guide bush 24 when the tube 13 is pulled too far upward. An access opening in the outer tube 14 required for screwing in the screw 31 is covered by a ring 32 which, in turn, forms a lower stop for the movement of the clamping sleeve 20.

The shape of the tubes 13, 14 is freely configurable with consideration for and while retaining the mutual anti-torsion protection. Further conceivable embodiments are oval, rectangular, or round telescopic tubes 13, 14 provided with an appropriate telescopic guidance.

What is claimed is:

1. A steering device for small vehicles which are operated via muscle power and/or electrically, comprising:
a transverse control arm,
a height-adjustable handlebar on which the transverse control arm is situated, the handlebar comprising two telescopic tubes having an inner tube and an outer tube, and a latching element radially movably mounted on the outer tube, wherein the inner tube comprises at least two openings or grooves which are formed at different heights and into which the latching element can latch into position, and
a height-adjustment and locking device comprising a clamping sleeve surrounding the two tubes at their connection point and being displaceable along the inner tube in the direction of the outer tube, the height adjustment and locking device having a conically tapering end portion on its inner side that engages around the outer tube, and
a spring which exerts a force against displacement of the height adjustment and locking device,
wherein in a relaxed state of the spring, the height adjustment and locking device acts on an outer surface of the latching element, which protrudes radially outward through an opening in the outer tube, and thereby presses the latching element radially inward.

2. The steering device as claimed in claim 1, wherein the outer surface of the latching element is configured to taper, corresponding to the conical end portion of the clamping sleeve.

3. The steering device as claimed in claim 1, wherein the spring is situated between a first guide bush which comprises a radial passage opening for the latching element and is non-rotatably situated in an end portion of the outer tube, and a second guide bush surrounding the inner tube, and the clamping sleeve is connected to the second guide bush.

4. The steering device as claimed in claim 3, wherein the inner tube includes a flattened circumferential portion, and the first guide bush includes, on its inner circumference, a corresponding flattened portion, and so the flattened portions of the inner tube and of the first guide bush form an anti-torsion safeguard of the inner tube with respect to the outer tube.

5. The steering device as claimed in claim 4, wherein the openings or grooves are situated in the flattened circumferential portion of the inner tube.

6. The steering device as claimed claim 3, wherein a lower edge of the first guide bush forms a safeguard against the inner tube being pulled out, the inner tube being provided, at its end, with a radially screwed-in screw which impacts the lower edge of the first guide bush when the inner tube is pulled too far out of the outer tube.

7. The steering device as claimed in claim 6, wherein an access opening to the screw on the inner tube is provided in the outer tube and the access opening can be covered toward the outside by an annular body, wherein the annular body forms a stop for the movement of the clamping sleeve.

8. The steering device as claimed in claim 1, wherein edges of the openings or grooves of the inner tube and the outer contour of the latching element are configured in such a way that, upon release of the outer surface of the latching element by the conical portion of the clamping sleeve, the latching element can be moved out of the openings or grooves of the inner tube simply by moving the inner tube relative to the outer tube.

9. The steering device as claimed in claim 1, wherein the spring is a coil spring.

10. The steering device as claimed in claim 1, wherein electrical and/or hydraulic lines are routed in an interior of the tubes.

11. The steering device as claimed in claim 10, wherein the lines are designed in a shape of a spiral.

12. A steering device for small vehicles which are operated via muscle power and/or electrically, comprising:
a transverse control arm,
a height-adjustable handlebar on which the transverse control arm is situated, the handlebar comprising two telescopic tubes having an inner tube and an outer tube, and a latching element radially movably mounted on the outer tube, wherein the inner tube comprises at least two openings or grooves which are formed at different heights and into which the latching element can latch into position, and
a height-adjustment and locking device comprising a clamping sleeve surrounding the two tubes at their connection point, and
a torsion spring that exerts a force against rotation of the clamping sleeve,
wherein the locking device is provided, on its inner side, with an eccentrically extending wall portion which engages around the outer tube and, in a relaxed state of the torsion spring, acts on an outer surface of the latching element, which protrudes radially outward through an opening in the outer tube, and thereby presses the latching element radially inward, and releases the latching element when the clamping sleeve makes a turning motion against the force of the torsion spring.
